(19) United States
(12) Patent Application Publication
(10) Pub. No.: US 2026/0251095 A1
(43) Pub. Date: Aug. 27, 2026

(54) METHOD TO SHUT DOWN AN INTERNAL COMBUSTION ENGINE

(71) Applicant: VOLVO TRUCK CORPORATION, Göteborg (SE)

(72) Inventors: Ayron CATTEAU, Göteborg (SE); Therese MÄSAK, Henån (SE)

(73) Assignee: VOLVO TRUCK CORPORATION, Göteborg (SE)

(21) Appl. No.: 19/547,099

(22) Filed: Feb. 23, 2026

(30) Foreign Application Priority Data
Feb. 27, 2025 (EP) 25160618.2

(51) Int. Cl. F02D 13/04; F01L 9/10; F01L 13/06; F01M 1/02; F01P 3/06; F01P 5/10; F02D 41/38

(52) U.S. Cl. CPC F02D 13/04; F01L 9/10; F01L 13/065; F01M 1/02; F01P 3/06; F01P 5/10; F02D 41/38

(57) ABSTRACT

A method to shut down an internal combustion engine further to a shutdown signal is described. The internal combustion engine has at least one exhaust valve to evacuate exhaust gas from the combustion and a compression brake device to open the exhaust valve when activated, and an oil circuit fluidically connected to the exhaust valve to provide oil at a predefined oil pressure. The method includes, after receiving the shutdown signal by the control unit, if the oil pressure is greater than or equal to a pressure threshold, activating the compression brake device during the compression stroke, if the oil pressure is lower than the pressure threshold, increasing the oil pressure to the pressure threshold and activating the compression brake device during the compression stroke once the oil pressure has reached the pressure threshold.

### TECHNICAL FIELD

The disclosure relates generally to internal combustion engines and more particularly to the shutdown phase of an internal combustion engine. In particular aspects, the disclosure relates to a method to shutdown an internal combustion engine. The disclosure can be applied to low-duty, medium-duty and is of particular interest for heavy-duty vehicles, such as trucks, buses, and construction equipment, among other vehicle types. Although the disclosure may be described with respect to a particular vehicle, the disclosure is not restricted to any particular vehicle.

### BACKGROUND

The shutdown phase refers to the phase during which fuel is no longer injected into the cylinders of the internal combustion engine. It results in the engine being allowed to come to a complete stop. In other words, the shutdown phase starts at an initiating event indicative of a requirement to lead the vehicle from a non-zero engine speed to an engine speed being zero. The engine speed of an internal combustion engine corresponds to the angular speed of its output shaft. The shutdown phase ends once the engine speed of the vehicle becomes zero. The initiating event may be the actuation of the key by the driver to stop the engine, or an automatic engine shutdown while driving.

During the shutdown of the internal combustion engine, the internal combustion engine speed decreases from a non-zero value to zero for a certain duration. It comes to the situation in which the engine rotates at lower speeds than usual speeds for the engine. The vibrations generated by the engine may be at or near the natural frequencies of the cab of the vehicle. It leads to vibrations of the cab with great amplitudes. This results in a noticeable shaking of the cab caused by the engine rotating at slow speed during its shutdown, which resonates with the natural frequencies of the cab structure and engine mounting. This shaking is felt by the driver, and is especially uncomfortable with the largest engines such as these equipping heavy-duty vehicles.

The disclosed technology falls within this context. It aims at offering a smooth braking solution, thereby overcoming the problem of the noticeable shaking of the cab during the shutdown of the internal combustion engine. More precisely, the disclosed technology significantly reduces the duration of the shutdown of the engine, resulting in a much shorter time spent at an engine speed corresponding to the natural frequencies of the cab. It results in a reduction, or even elimination, of the shaking of the cab felt by the driver.

### SUMMARY

According to a first aspect of the disclosure, a method to shut down an internal combustion engine further to a shutdown signal, said internal combustion engine comprising:
a plurality of cylinders,
a valves system comprising, for each cylinder, at least one exhaust valve configured to evacuate exhaust gas from the combustion,
an oil circuit fluidically connected to the valves system to provide oil at a predefined oil pressure to allow the valves to open and close,
for each cylinder: a compression brake device associated to one of the exhaust valve, said compression brake device being configured to place said exhaust valve in an open position during a compression stroke of the internal combustion engine when activated,
a control unit operatively connected to the oil circuit and the compression brake devices, and configured to receive the shutdown signal and send commands to the internal combustion engine,
   comprises the steps of, after receiving the shutdown signal by the control unit:
measuring an oil pressure in the oil circuit,
if the oil pressure is greater than or equal to a pressure threshold, activating the compression brake devices during the compression stroke,
if the oil pressure is lower than the pressure threshold, increasing the oil pressure to the pressure threshold and activating the compression brake devices during the compression stroke once the oil pressure has reached the pressure threshold.

When the engine shutdown begins and if the oil pressure in the oil pipe of the oil circuit is sufficient, the compression brake device is activated during the compression stroke. If the oil pressure in the oil pipe of the oil circuit is not sufficient, the oil pressure is increased until a pressure threshold and then, the compression brake device is activated.

The actuation of the compression brake device during the compression stroke results in the opening of the exhaust valve. The combustion chamber is open in an unusual stroke. Indeed, due to the exhaust valve being open during the compression stroke, the compression cannot take place. Combustion is prevented to occur as it should in a normal use. The exhaust valve being open, it constitutes a port for exhaust gas from the exhaust circuit to enter the cylinder through the exhaust valve. The piston encounter higher resistance during its movement up to the top dead center. The deceleration of the engine during the shutdown phase is increased. The engine speed reaches the zero value faster than it would without the method of the disclosed technology. It results in the internal combustion engine spending very short time rotating at the natural frequencies of the cab, eliminating the shaking felt by the driver.

Optionally in some examples, including in at least one preferred example, the internal combustion engine comprising piston cooling jet valves fluidically connected to the oil circuit, the step of increasing the oil pressure comprises the step of closing the cooling jet valves. Piston cooling jet valves are installed to enable oil jets against the piston outer surface to prevent overheating by dissipating excess heat. When it is required to increase the oil pressure within the oil circuit, the step of closing the cooling jet valves avoids letting oil escape against the piston to be recovered in the oil crankcase before being pressurized again. This reduces the compression effort to be delivered by the main oi pump of the oil circuit.

Optionally in some examples, including in at least one preferred example, the oil circuit comprising a variable oil pump configured to dynamically adapt the oil pressure to a target pressure within the oil circuit, the step of increasing the oil pressure comprises the step of activating the variable oil pump.

The use of the variable oil pump ensures that the oil pressure in the oil circuit can be raised at the required level of pressure, thereby ensuring the activation of the compression brake devices, whatever the oil pressure conditions are when the shutdown signal is sent to the control unit.

Optionally in some examples, including in at least one preferred example, the method further comprises a step of deactivating the compression brake devices when the internal combustion engine has reached a predefined non-zero engine speed.

Before the internal combustion engine stops rotating, the compression brake device is deactivated. This step enables oil to escape from the compression brake device, which can only happen while the internal combustion engine is rotating.

Optionally in some examples, including in at least one preferred example, the method further comprises a step of stopping fuel injection into the plurality of cylinders, simultaneously or prior to the step of activating the compression brake devices. As the internal combustion engine is not supplied with fuel, the combustion cannot take place. It leads to a greater deceleration of the engine speed. Moreover, as a shutdown of the engine is expected, stopping fuel injection when it is not needed contributes to a lower fuel consumption.

Optionally in some examples, including in at least one preferred example, the method further comprises a step of increasing the backpressure on the pistons of the plurality of cylinders, simultaneously or prior to the step of activating the compression brake devices.

Optionally in some examples, including in at least one preferred example, each compression brake device comprising a hydraulic actuator, the step of activating the compression brake devices comprises the step of providing the hydraulic actuators with oil at a predetermined pressure.

A hydraulic actuator presents the advantage of requiring a minimum engine oil pressure to activate and remain activated. The pressure threshold to activate the compression brake device does not require to be a high value and it can be reached quite easily.

According to a second aspect of the disclosure, an internal combustion engine comprises:
a plurality of cylinders,
a valves system comprising, for each cylinder, at least one exhaust valve configured to evacuate exhaust gas from the combustion,
an oil circuit fluidically connected to the valves system to provide oil at a predefined oil pressure to allow the valves to open and close,
for each cylinder: a compression brake device associated to one of the exhaust valve, said compression brake device being configured to place said exhaust valve in an open position during a compression stroke of the internal combustion engine when activated,
a control unit operatively connected to the oil circuit and the compression brake devices, and configured to receive the shutdown signal and send commands to the internal combustion engine,
   said control unit being further configured to:
send a command of measuring the oil pressure in the oil circuit,
if the oil pressure is greater than or equal to a pressure threshold, send an activation command of the compression brake devices during the compression stroke,
if the oil pressure is lower than the pressure threshold, send a command of increasing the oil pressure to the pressure threshold and an activation command of the compression brake devices during the compression stroke once the oil pressure has reached the pressure threshold.

Optionally in some examples, including in at least one preferred example, the internal combustion engine further comprises piston cooling jet valves fluidically connected to the oil circuit, and the control unit is configured to send a command of closing the cooling jet valves to increase the oil pressure.

Optionally in some examples, including in at least one preferred example, the oil circuit comprises a variable oil pump configured to dynamically adapt the oil pressure within the oil circuit, and the control unit is configured to send an activation command of the variable oil pump to increase the oil pressure.

Optionally in some examples, including in at least one preferred example, the control unit is configured to send a deactivation command of the compression brake devices when the internal combustion engine has reached a predefined non-zero engine speed.

Optionally in some examples, including in at least one preferred example, the control unit is configured to send a command of stopping fuel injection into the plurality of cylinders, preferably simultaneously to the activation command of the compression brake devices.

Optionally in some examples, including in at least one preferred example, the control unit is configured to send a command of increasing the backpressure on the pistons of the plurality of cylinders, preferably simultaneously to the activation command of the compression brake devices.

According to a third aspect of the disclosure, a control unit intended to equip an internal combustion engine comprises:
a plurality of cylinders,
a valves system comprising, for each cylinder, at least one exhaust valve configured to evacuate exhaust gas from the combustion,
an oil circuit fluidically connected to the valves system to provide oil at a predefined oil pressure to allow the valves to open and close,
for each cylinder: a compression brake device associated to one of the exhaust valve, said compression brake device being configured to place said exhaust valve in an open position during a compression stroke of the internal combustion engine when activated,
   said control unit being intended to be operatively connected to the oil circuit and the compression brake devices, and configured to receive the shutdown signal and send commands to the internal combustion engine, and further configured to:
send a command of measuring an oil pressure in the oil circuit,
if the oil pressure is greater than or equal to a pressure threshold, send an activation command of the compression brake devices during the compression stroke,
if the oil pressure is lower than the pressure threshold, send a command of increasing the oil pressure to the pressure threshold and an activation command of the compression brake devices during the compression stroke once the oil pressure has reached the pressure threshold.

Optionally in some examples, including in at least one preferred example, the control unit is configured to send a command of closing cooling jet valves of the internal combustion engine, said valves being fluidically connected to the oil circuit.

Optionally in some examples, including in at least one preferred example, the control unit is configured to send an activation command of a variable oil pump of the oil circuit, said variable oil pump being configured to dynamically adapt the oil pressure within the oil circuit.

Optionally in some examples, including in at least one preferred example, the control unit is configured to send a deactivation command of the compression brake devices when the internal combustion engine has reached a predefined non-zero engine speed.

Optionally in some examples, including in at least one preferred example, the control unit is configured to send a command of stopping fuel injection into the plurality of cylinders, preferably simultaneously to the activation command of the compression brake device.

According to a fourth aspect of the disclosure, a vehicle, for example a truck, comprises such an internal combustion engine.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is a perspective view of an exemplary vehicle equipped with an internal combustion engine to which the method according to an example can be applied.

FIG. 2 is a schematic diagram showing the evolution of the engine speed during a shutdown phase without applying the method of the disclosed technology.

FIG. 3 is a schematic diagram showing the evolution of the engine speed during a shutdown phase when applying the method of the disclosed technology.

FIG. 4 schematically represents the steps of the method to shut down an internal combustion engine according to the disclosed technology.

FIG. 5 schematically represents an internal combustion engine of the disclosed technology.

It should be understood that the appended drawings are not necessarily to scale, presenting somewhat simplified representation of various preferred features illustrative of the basic principles of the disclosed technology. The specific design features of the disclosed technology as disclosed herein, including, for example, specific dimensions, orientations, locations, and shapes will be determined in part by the particular intended application and use environment.

### DETAILED DESCRIPTION

The detailed description set forth below provides information and examples of the disclosed technology with sufficient detail to enable those skilled in the art to practice the disclosure.

The characteristics, variants and various examples of the disclosed technology, as they have been described or as they will be presented in the detailed description which follows, can be associated with each other, according to various combinations, to the extent that they are not incompatible or exclusive with respect to each other. In particular, it will be possible to imagine variants of the disclosed technology comprising only a selection of characteristics described subsequently isolated from the other characteristics described, if this selection of characteristics is sufficient to confer a technical advantage and/or to differentiate the disclosed technology compared to the prior art.

For the sake of clarity, the same elements are designated by the same references in the different figures.

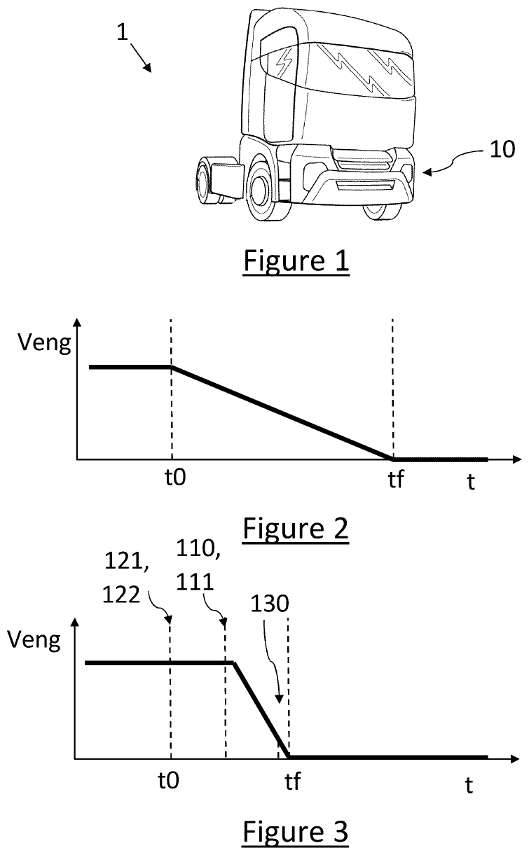

FIG. 1 is a perspective view of an exemplary vehicle equipped with an internal combustion engine 10 to which the method according to an example can be applied. As illustrated, vehicle 1 is a truck. Nevertheless, the method according to the disclosed technology may be applied to any internal combustion engine and the vehicle may be any vehicle, for example a bus or a car. As the method for the disclosed technology aims at limiting the shaking of the passenger compartment structure during the shutdown of the internal combustion engine, its application is particularly appreciated for heavy-duty vehicles like trucks.

FIG. 2 is a schematic diagram showing the evolution of the engine speed during a shutdown phase without applying the method of the disclosed technology. The abscissa axis indicates the time t, and the ordinate axis indicates the engine speed Veng of the internal combustion engine. The engine speed is defined in revolution per minute (rpm), it corresponds to the angular speed of the engine output shaft. As illustrated, the engine speed Veng is initially non-zero. As time equals to t0, the shutdown begins. It means that a decision was taken to allow the internal combustion engine to a complete stop. In other words, at time t0, there is the occurrence of an initiating event for shutting down the engine, for example from the driver through the key of the vehicle or through an automatic shutdown further to a corresponding situation detected by a control unit of the vehicle. The initiating event for the shutdown of the internal combustion engine is accompanied by the step of stopping the fuel injection. As the internal combustion engine is no longer supplied with fuel, the engine speed Veng decreases. As plotted, the engine speed Veng decreases from its initial value to the zero value. It corresponds to the phase after t0 and before a final time noted tf. At the final time tf, the engine speed Veng reaches the zero value. It means that the internal combustion engine is shut down. As explained above, during the shutdown, that is to say between t0 and tf, it comes to a phase during which the engine rotates at lower speeds than usual speeds for the engine. In this phase, the engine generates vibrations that may be at or near the natural frequencies of the cab of the vehicle. These vibrations of the cab have typically great amplitudes and lead to the shaking of the cab. As the shutdown duration may be quite long, the duration of the shaking of the cab might also be long enough to provide an unpleasant sensation and even a safety risk as the driver is uncomfortable in his/her driving position.

The method according to the disclosed technology aims at avoiding such a situation. The principle of the disclosed technology will be detailed below.

FIG. 3 is a schematic diagram showing the evolution of the engine speed Veng during a shutdown phase of the same internal combustion engine as in the case presented in FIG. 2, but this time when applying the method of the disclosed technology. As for FIG. 2, the abscissa axis indicates the time t, and the ordinate axis indicates the engine speed Veng of the internal combustion engine. Similarly, as the situation in FIG. 2, an initiating event of shutting down the engine is triggered at time t0. Further to this event, the engine speed Veng is decreased. During the shutdown phase, the method according to the disclosed technology is applied. The method of the disclosed technology, comprising the steps 110, 111, 121, 122 and 130, will be described in detail below. It can be noticed that, in comparison to the situation plotted in FIG. 2 without the method of the disclosed technology, the engine speed Veng decreases more rapidly and hence according to a steeper slope until it reaches the zero value. As can be seen, the final time tf at which the zero engine speed is reached occurs earlier than in the situation represented in FIG. 2. Therefore, the deceleration of the engine is increased thanks to the method of the disclosed technology. It results in a much shorter time spent rotating at the natural frequencies of the cab, thereby decreasing and even eliminating the shaking felt by the driver in the cab.

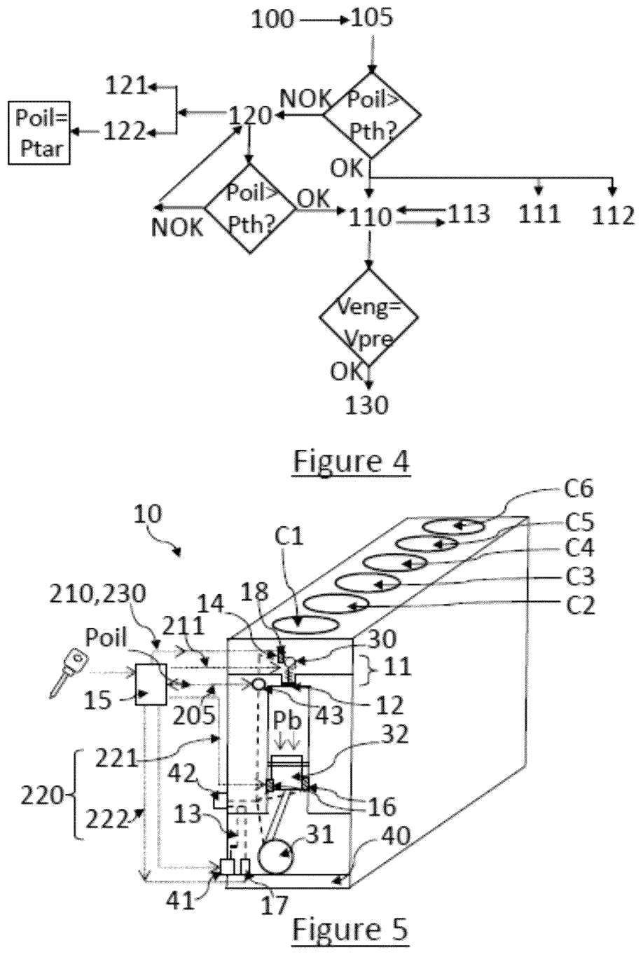

The disclosed technology will be described based on both FIG. 4 and FIG. 5.

FIG. 4 schematically represents the steps of the method to shut down an internal combustion engine 10 according to the disclosed technology.

FIG. 5 schematically represents an internal combustion engine 10 of the disclosed technology.

As mentioned before, the shutdown signal is the initiating event of shutting down the engine. The shutdown signal is an information sent from a control unit 15 further to the detection of a situation enabling an automatic shutdown of the engine or further to a command from the driver through actuation of the key of the vehicle.

The internal combustion engine 10 comprises a plurality of cylinders C1, C2, C3, C4, C5, C6. In FIG. 5, the internal combustion engine is a 6-cylinder in line engine. This arrangement is an example of an engine to which the method of the disclosed technology can be applied. But the scope of the disclosed technology is not limited to this kind of engine and can be applied to any other type of internal combustion engine, whatever the number of cylinders and their disposition in relation to each other are.

The internal combustion engine 10 comprises a valves system 11. The valves system 11 comprises, for each cylinder, at least one intake valve (not depicted) and at least one exhaust valve 12. The intake valve(s) is/are configured to enable the supply of air into the cylinder on which it is mounted, whereas fuel in directly injected into the cylinder through a fuel injector (not represented). It may be noted that the disclosed technology applies similarly to an internal combustion engine having intake valve(s) configured to enable the supply of a mixture of air and fuel into the cylinder on which it is mounted.

The exhaust valve(s) 12 is/are configured to evacuate exhaust gas from the combustion. The intake valves, respectively the exhaust valves, allow a flow to enter (the flow is a flow of air or air/fuel mixture), respectively to exit (the flow is a flow of exhaust gas), the combustion chamber within the cylinder. Air enters through the intake valve and exhaust gases exit through the exhaust valve. The valves of a cylinder are synchronized with the piston 32 moving inside the cylinder thanks to the movements of a camshaft 30 and the crankshaft 31, as it is known in the prior art. For that purpose, the valves system 11 comprises a camshaft 30 that controls their opening and closing according to a well-defined sequence. Indeed, the camshaft 30 rotates and the cams on the camshaft 30 activate the valves. A valve opens when it is pushed down by the cam of the camshaft 30. The camshaft springs keep the valve closed thanks to the mechanism that pulls it up.

The operation of a four-stroke engine comprises, for each cylinder and in a non-simultaneous way for all the cylinders, four distinct phases, or strokes: intake, compression, expansion and finally exhaust. During the intake stroke, the intake valve is open. The piston 32 goes down, and air (or a mixture of air and fuel) is sucked into the combustion chamber.

The intake stroke is followed by the compression stroke during which the combustion chamber is usually completely hermetically sealed. If applicable, fuel is injected into the cylinder. The piston 32 rises and compresses the mixture of air and fuel, leading to an increased pressure and temperature of the mixture. The expansion stroke occurs as the piston 32 continues to rise until it approaches the spark plug (in case of a gasoline engine). A spark is fired from the spark plug electrodes, which ignites the air and fuel mixture (it should be noted here that in case of a Diesel engine, the air and fuel mixture undergoes an auto-ignition thanks to the temperature and pressure conditions within the combustion chamber). The mixture explodes, which increases both the pressure and the temperature in the combustion chamber. The piston 32 is then violently returned to its bottom dead center. The exhaust stroke takes place: the exhaust valve opens and the piston 32 rises along the combustion chamber, pushing the burnt gases (exhaust gases) towards the exhaust circuit.

For the sake of simplifying the drawing, only one cylinder (cylinder C1) is schematically represented. It is to be understood that the other cylinders (C2, C3, C4, C5, C6) comprise the same elements as cylinder C1. Also, only one exhaust valve 12 is depicted as it is an important element of the disclosed technology. For ease of understanding, the disclosed technology will be described based on one exhaust valve per cylinder. Nevertheless, as a cylinder generally comprises two exhaust valves to enable a high flow rate of exhaust gases flowing out of the cylinder, it is to be underlined that the scope of the disclosed technology is not limited by the number of exhaust valves per cylinder, and the disclosed technology applies similarly to one or two exhaust valves, or even more. As depicted in FIG. 5, the exhaust valve 12 is in its closed position.

At this stage, it should be noticed that the exhaust valve 12 is schematically represented in a simple manner, the valve stem extending vertically and the valve head extending horizontally. The disclosed technology applies similarly with one (or more) exhaust valve having their valve stem tilted from the vertical.

The internal combustion engine 10 comprises an oil circuit 13 fluidically connected to the valves system 11 to provide oil at a predefined oil pressure to allow the valves 12 to open and close, as it will be detailed further on in the framework of the disclosed technology.

The oil circuit 13 comprises oil intended to lubricate elements of the internal combustion engine 10 and/or to enable movement of some parts thanks to the oil being at a predefined pressure. The oil circuit 13 comprises the oil crankcase 40 that serves as a receptacle for the oil. The oil circuit 13 comprises a main oil pump 41. The main oil pump 41 ensures the pressurization of the oil inside the oil circuit 13. The oil circuit 13 further comprises an oil filter 42, generally made of paper or cotton cloth, contained in a metal cartridge. It retains impurities, suspended in the oil, which could alter the parts in operation, for example combustion residues that entered the oil circuit and/or oil deterioration products. The oil circuit 13 further comprises pipes fluidically connecting elements of the oil circuit 13 between them. These pipes are represented in dashed lines in FIG. 5.

The oil, coming from the oil crank case 40 and sucked by the main oil pump 41, enters the oil filter 42, passes through the oil filter 42. Downstream of the oil filter 42, oil is distributed through the oil circuit via the oil pipes. Oil at a predefined pressure is directed to the crankshaft 31, to the valves system 11, and, if applicable, to the piston 32 and more specifically to piston cooling jet valves 16 oriented to the outer surface of the bottom of the piston 32. The piston cooling jet valves 16 are intended to proceed with oil jets to prevent overheating by dissipating excess heat.

The internal combustion engine 10 further comprises, for each cylinder, a compression brake device 14 associated to one of the exhaust valves 12. In other words, there is a compression brake device 14 for each cylinder. For a 6-cylinder engine, there are six compression brake devices 14. For each cylinder, the compression brake device 14 may be associated to one exhaust valve 12 if there is one exhaust valve, or the compression brake device 14 may be associated to the two exhaust valves if there are two exhaust valves per cylinder.

The compression brake device 14 is configured to place the exhaust valve 12 to which it is associated in an open position during a compression stroke of the internal combustion engine 10 when said compression brake device 14 is activated. The compression brake device 14 may comprise a hydraulic actuator 18. As mentioned above, the oil circuit 13 is fluidically connected to the valves system 11 to provide oil at a predefined oil pressure to allow the exhaust valves 12 to open and close. More precisely, the compression brake devices 14 are gathered under the term of compression brake. The compression brake also comprises an oil pressure regulator fluidically connected to the oil circuit 13 of the internal combustion engine and to each compression brake devices 14. The oil pressure regulator is intended to provide oil from the oil circuit 13 to the compression brake devices 14 to operate.

Once the compression brake device 14 is activated, oil at a predefined pressure is provided to the hydraulic actuator 18, thereby leading to a predetermined movement of the hydraulic actuator 18, for example a translation of its extremity towards the exhaust valve, so as to push it downwards to make the exhaust valve moving from its closed position (wherein no fluid flow can pass through it) to its open position (wherein fluid flow is allowed to pass through it).

The internal combustion engine 10 further comprises a control unit 15 operatively connected to the oil circuit 13 and the compression brake devices 14, and configured to receive at least the shutdown signal and send commands to the internal combustion engine 10. The signals received by the control unit 15 and the commands sent by the control unit 15 are schematically represented by dotted lines. The control unit 15 being operatively connected to the oil circuit 13 and the compression brake devices 14 means that the control unit 15 is able to send instructions to at least one actuator linked to at least one part of the oil circuit 13 and to at least one actuator linked to at least one part of the compression brake device 14. When receiving the shutdown signal, the control unit 15 sends commands to said actuators to result in modifications to the compression brake devices 14 and, if necessary, to the oil circuit 13. These aspects will be detailed together with the description of the method to shut down the internal combustion engine 10 further to the shutdown signal according to the disclosed technology.

As it will appear clearly when reading the description of the details of the disclosed technology below, the communication between the control unit 15 and the other elements of the internal combustion engine 10 is realized through sensor signals and actuator commands. The transmission of signals and commands to and from the control unit 15 is performed by known communication means, such as wired connection, wireless connection, local area network bus, serial peripheral interface bus, etc. For these purposes, the control unit 15 may comprise at least one processor. Under the term processor, it should be understood at least one of a processor, microprocessor, Application Specific Integrated Circuit (also known under its acronym ASIC), electronic circuit, central processing unit. The control unit 15 may comprise at least one memory component (read only, programmable read only, random access, hard drive, etc.) able to store machine readable instructions accessible by the processor to provide the desired functionality. The disclosed technology is based on an innovative control of the internal combustion engine 10.

The method to shut down the internal combustion engine 10 according to the disclosed technology comprises a first step 100 of receiving the shutdown signal. As an example, the driver may turn the key to shut down the internal combustion engine 10. This is a shutdown signal that is transmitted to the control unit 15. The method of the disclosed technology comprises a step 105 of measuring an oil pressure Poil in the oil circuit 13. If the oil pressure Poil inside the oil circuit 13 is greater than or equal to a pressure threshold Pth, the method of the disclosed technology comprises the step 110 of activating the compression brake devices 14 during the compression stroke of the internal combustion engine. To do so, the method of the disclosed technology may comprise a step 105 of verification of the oil pressure Poil of the oil circuit 13. The control unit 15 sends a request to a pressure sensor 43 mounted in the oil pipes of the oil circuit 13. As feedback, the control unit 15 receives the measured value of the oil pressure in the oil pipe (that is to say downstream of the main oil pump 41) and compares this value to the pressure threshold Pth. If this value is greater than or equal to the pressure threshold Pth, it means that the oil in the oil circuit 13 is pressurized enough to allow the predetermined movement of the hydraulic actuator 18. The control unit 15 sends a command to activate the compression brake devices 14 during the compression stroke. In the following, the disclosed technology will be described with a compression brake device 14 comprising a hydraulic actuator 18. In this case, each compression brake device 14 comprises a hydraulic actuator 18 to put the exhaust valve 12 into its open position.

It leads to the hydraulic actuator 18 applying a force on the closed exhaust valve 12 to place it in its open position during the compression stroke of the internal combustion engine 10. The step 110 of activating the compression brake devices 14 comprises the step 113 of providing the hydraulic actuators 18 with oil at a predetermined pressure.

In a normal use, that is to say without applying the method of the disclosed technology, the exhaust valve 12 is in its closed position during the compression stroke. This position enables the mixture of air and fuel to be compressed to lead to the combustion process of fuel with dioxygen of air. The piston movement occurring during the combustion process contributes to making the output shaft of the internal combustion engine rotate. It produces mechanical power intended to be transmitted, via a transmission line, from the output shaft of the engine to the wheels to ensure the vehicle propulsion.

The method of the disclosed technology takes place in the shutdown phase of the internal combustion engine. By activating the compression brake device 14 during the compression stroke, the hydraulic actuator 18 puts the exhaust valve 12 in its open position during the compression stroke of the internal combustion engine 10, that is to say when the piston moves from the bottom dead center to the top dead center. As the exhaust valve is open, the compression cannot take place properly. Combustion is prevented from occurring as it should in a normal use. Moreover, the exhaust valve is open and gases from the exhaust circuit may penetrate the cylinder through the exhaust valve 12, thereby leading to a force applied on the piston head against its movement up to the top dead center. The step 110 of activating the compression brake devices 14 during the compression stroke of the internal combustion engine enables to significantly slow down the pistons movement and limit the occurrence of the combustion process. Therefore, the engine speed reaches the zero value faster than it would without the method of the disclosed technology. The reduction of the shutdown duration is illustrated in FIG. 3. At time t0 an initiating event of shutting down the engine occurs. Further to the step 110 of activating the compression brake devices 14 during the compression stroke, the final time tf of the shutdown phase is reached well before the final tf without the step 110 (as illustrated in FIG. 2). The duration of the shutdown phase with the method of the disclosed technology is considerably reduced in comparison to the duration of the shutdown phase without the method of the disclosed technology. The duration at which the engine has a slow engine speed leading to the resonance with the natural frequencies of the cab structure is shortened. It results in preventing the shaking felt by the driver.

The core of the disclosed technology was described in the case of the oil circuit 13 having oil flowing through the oil pipes with a high enough pressure to enable the activation of the compression brake devices 14. Nevertheless, it may occur that the oil pressure Poil is lower than the pressure threshold Pth. During the step 105 of verification of the oil pressure Poil of the oil circuit 13, the control unit 15 receives the value of the oil pressure and compares this value to the pressure threshold Pth. If this value is less than the pressure threshold Pth, it means that the oil in the oil pipes (downstream of the main oil pump) of the oil circuit 13 is not pressurized enough to allow the predetermined movement of the hydraulic actuator 18. In this case, the method of the disclosed technology comprises a step 120 of increasing the oil pressure Poil to the pressure threshold Pth. Once the oil pressure Poil has reached the pressure threshold Pth, the step 110 is triggered, the compression brake devices 14 are activated during the compression stroke. It is therefore ensured that the compression brake devices 14 are activated only when the oil pressure in the oil circuit 13 is above the pressure threshold Pth.

Optionally in some examples, including in at least one preferred example, the internal combustion engine 10 comprises piston cooling jet valves 16 fluidically connected to the oil circuit 13. When piston cooling jet valves 16 are present, the step 120 of increasing the oil pressure Poil in the oil circuit 13 advantageously comprises the step 121 of closing the cooling jet valves 16. In this case, the control unit 15 is configured to send a command 221 of closing the cooling jet valves 16 to increase the oil pressure Poil.

In normal use, the cooling jet valves 16 are intended to perform oil jets on the outer surface of the bottom of the piston 32 to prevent the piston from overheating. In other words, a part of the pressurized oil of the oil circuit 13 leaves the oil circuit 13 through the piston cooling jet valves 16. The step 121 of closing the cooling jet valves 16 temporarily interrupts the cooling of the piston via the cooling jet valves 16, thereby ensuring that oil stays within the oil circuit 13 whose pressure should be increased.

Optionally in some examples, including in at least one preferred example, the oil circuit 13 comprises a variable oil pump 17 configured to dynamically adapt the oil pressure Poil to a target pressure Ptar within the oil circuit 13. In this case, the control unit 15 is configured to send an activation command 222 of the variable oil pump 17 to the variable oil pump 17 to increase the oil pressure Poil in the oil circuit 13. When a variable oil pump 17 is present in the oil circuit 13, the step 120 of increasing the oil pressure Poil advantageously therefore comprises the step 122 of activating the variable oil pump 17. Such a variable oil pump 17 uses adjustable vanes that dynamically adapt to the oil pressure demands. It results in a precise delivery of oil as required by the internal combustion engine. As the vane angles of the variable oil pump 17 are dynamically adjusted, the variable oil pump 17 can adapt its output to be in accordance with the oil pressure requirements in the oil circuit 13. It enables to ensure that the right level of pressurization of the oil in the oil circuit 13 is achieved when it is required to activate the compression brake devices 14.

Optionally in some examples, including in at least one preferred example, the control unit 15 is configured to send a deactivation command 230 of the compression brake devices 14 when the internal combustion engine 10 has reached a predefined non-zero engine speed Vpre. In this case, the method according to the disclosed technology comprises a step 130 of deactivating the compression brake devices 14 when the internal combustion engine 10 has reached a predefined non-zero engine speed Vpre. The deactivation of the compression brake devices 14 is performed before the internal combustion engine 10 stops rotating. This is done at the predefined non-zero engine speed Vpre in order for the oil to have the opportunity to escape the compression brake devices 14, which can only happen while the internal combustion engine 10 is rotating. As illustrated in FIG. 3, the step 130 of deactivating the compression brake devices 14 is realized at a time when the engine speed Vpre is very low but non-zero. At his stage of the shutdown, the speed of the internal combustion engine 10 is low enough to no longer require the action of the compression brake devices 14. On top of enabling oil inside the compression brake devices to escape, this means that the compression brake devices 14 are operational for the next step 110 of activating them for the next shutdown phase.

Optionally in some examples, including in at least one preferred example, the control unit 15 is configured to send a command 211 of stopping fuel injection into the plurality of cylinders C1, C2, C3, C4, C5, C6 preferably simultaneously to the activation command 210 of the compression brake devices 14. In this case, the method of the disclosed technology comprises a step 111 of stopping fuel injection into the plurality of cylinders C1, C2, C3, C4, C5, C6, simultaneously or prior to the step 110 of activating the compression brake devices 14. As no more fuel is injected into the cylinders, combustion cannot take place. This contributes to reaching as fast as possible the shutdown of the internal combustion engine.

Optionally in some examples, including in at least one preferred example, the control unit 15 is configured to send a command 212 of increasing the backpressure Pb on the pistons of the plurality of cylinders C1, C2, C3, C4, C5, C6, preferably simultaneously to the activation command 210 of the compression brake devices 14. In this case, the method of the disclosed technology comprises a step 112 of increasing the backpressure Pb on the pistons of the plurality of cylinders C1, C2, C3, C4, C5, C6, simultaneously or prior to the step 110 of activating the compression brake devices 14. The increase of the backpressure Pb on the piston of the cylinders may be achieved by an exhaust throttle mounted in the exhaust line extending from the exhaust manifold to the exhaust aftertreatment system. Further to the exhaust stroke, the exhaust gases travel through the exhaust line toward the exhaust aftertreatment system before being released into the atmosphere. The increase of the backpressure Pb can be obtained by closing the exhaust throttle. It prevents the exhaust gases from leaving easily the exhaust line, thereby causing the backpressure to increase. Such an exhaust throttle may be pneumatically-driven, in which case it is controlled by an air valve unit. Activating the compression brake device during the compression stroke together with the step of closing the exhaust throttle result in the reduction of the duration of the shutdown.

The disclosed technology relies on the use of the compression brake to activate the compression brake devices 14 during the compression stroke when a shutdown is initiated. The activation of the compression brake devices 14 during the compression stroke opens the exhaust valves 12 during the stroke when the piston moves up from the bottom dead center to the top dead center. Opening the exhaust valves during the compression stroke constitutes a major hindrance to combustion. The speed of the piston movement is significantly reduced. Thanks to the disclosed technology, the engine speed reaches the zero value very fast. The duration of the shutdown phase is considerably reduced. As a consequence, less time spent is at an engine speed corresponding to the natural frequencies of the cab (in comparison to solutions of the prior art). It results in a smooth braking solution with a reduction, or even elimination, of the shaking of the cab felt by the driver.

Example 1: A method to shut down an internal combustion engine (10) further to a shutdown signal, said internal combustion engine (10) comprising:
a plurality of cylinders (C1, ..., C6),
a valves system (11) comprising, for each cylinder, at least one exhaust valve (12) configured to evacuate exhaust gas from the combustion,
an oil circuit (13) fluidically connected to the valves system (11) to provide oil at a predefined oil pressure to allow the valves (12) to open and close,
for each cylinder: a compression brake device (14) associated to one of the exhaust valve (12), said compression brake device (14) being configured to place said exhaust valve (12) in an open position during a compression stroke of the internal combustion engine (10) when activated,
a control unit (15) operatively connected to the oil circuit (13) and the compression brake devices (14), and configured to receive the shutdown signal and send commands to the internal combustion engine (10),
   said method comprising the steps of, after receiving (100) the shutdown signal by the control unit (15):
measuring (105) an oil pressure (Poil) in the oil circuit (13),
if the oil pressure (Poil) is greater than or equal to a pressure threshold (Pth), activating the compression brake devices (110) during the compression stroke,
if the oil pressure (Poil) is lower than the pressure threshold (Pth), increasing (120) the oil pressure (Poil) to the pressure threshold (Pth) and activating (110) the compression brake devices (14) during the compression stroke once the oil pressure (Poil) has reached the pressure threshold (Pth).

Example 2: The method of example 1, the internal combustion engine (10) comprising piston cooling jet valves (16) fluidically connected to the oil circuit (13), wherein the step (120) of increasing the oil pressure (Poil) comprises the step (121) of closing the cooling jet valves (16).

Example 3: The method of example 1 or 2, the oil circuit (13) comprising a variable oil pump (17) configured to dynamically adapt the oil pressure (Poil) to a target pressure (Ptar) within the oil circuit (13), wherein the step (120) of increasing the oil pressure (Poil) comprises the step (122) of activating the variable oil pump (17).

Example 4: The method of any one of examples 1 to 3, further comprising a step (130) of deactivating the compression brake devices (14) when the internal combustion engine (10) has reached a predefined non-zero engine speed (Vpre).

Example 5: The method of any one of examples 1 to 4, further comprising a step (111) of stopping fuel injection into the plurality of cylinders (C1, ..., C6), simultaneously or prior to the step (110) of activating the compression brake devices (14).

Example 6: The method of any one of examples 1 to 5, further comprising a step (112) of increasing the backpressure (Pb) on the pistons of the plurality of cylinders (C1, ..., C6), simultaneously or prior to the step (110) of activating the compression brake devices (14).

Example 7: The method of any one of examples 1 to 6, each compression brake device (14) comprising an hydraulic actuator (18), wherein the step (110) of activating the compression brake devices (14) comprises the step (113) of providing the hydraulic actuators (18) with oil at a predetermined pressure.

Example 8: An internal combustion engine (10) comprising:
a plurality of cylinders (C1, ..., C6),
a valves system (11) comprising, for each cylinder, at least one exhaust valve (12) configured to evacuate exhaust gas from the combustion,
an oil circuit (13) fluidically connected to the valves system (11) to provide oil at a predefined oil pressure to allow the valves to open and close,
for each cylinder: a compression brake device (14) associated to one of the exhaust valve (12), said compression brake device (14) being configured to place said exhaust valve (12) in an open position during a compression stroke of the internal combustion engine (10) when activated,
a control unit (15) operatively connected to the oil circuit (13) and the compression brake devices (14), and configured to receive the shutdown signal and send commands to the internal combustion engine (10),
   said control unit (15) being further configured to:
send a command (205) of measuring an oil pressure (Poil) in the oil circuit (13),
if the oil pressure (Poil) is greater than or equal to a pressure threshold (Pth), send an activation command (210) of the compression brake devices (14) during the compression stroke,
if the oil pressure (Poil) is lower than the pressure threshold (Pth), send a command (220) of increasing the oil pressure (Poil) to the pressure threshold (Pth) and an activation command (210) of the compression brake devices (14) during the compression stroke once the oil pressure (Poil) has reached the pressure threshold (Pth).

Example 9: The internal combustion engine (10) of example 8, further comprising piston cooling jet valves (16) fluidically connected to the oil circuit (13), wherein the control unit (15) is configured to send a command (221) of closing the cooling jet valves (16) to increase the oil pressure (Poil).

Example 10: The internal combustion engine (10) of example 8 or 9, wherein the oil circuit (13) comprises a variable oil pump (17) configured to dynamically adapt the oil pressure (Poil) within the oil circuit (13), wherein the control unit (15) is configured to send an activation command (222) of the variable oil pump (17) to increase the oil pressure (Poil).

Example 11: The internal combustion engine (10) of any one of examples 8 to 10, wherein the control unit (15) is configured to send a deactivation command (230) of the compression brake devices (14) when the internal combustion engine (10) has reached a predefined non-zero engine speed (Vpre).

Example 12: The internal combustion engine (10) of any one of examples 8 to 11, wherein the control unit (15) is configured to send a command (211) of stopping fuel injection into the plurality of cylinders (C1, ..., C6), preferably simultaneously to the activation command (210) of the compression brake devices (14).

Example 13: The internal combustion engine (10) of any one of examples 8 to 12, wherein the control unit (15) is configured to send a command (212) of increasing the backpressure (Pb) on the pistons of the plurality of cylinders (C1, ..., C6), preferably simultaneously to the activation command (210) of the compression brake devices (14).

Example 14: A control unit (15) intended to equip an internal combustion engine (10) comprising:
a plurality of cylinders (C1, ..., C6),
a valves system (11) comprising, for each cylinder, at least one exhaust valve (12) configured to evacuate exhaust gas from the combustion,
an oil circuit (13) fluidically connected to the valves system (11) to provide oil at a predefined oil pressure to allow the valves to open and close,
for each cylinder: a compression brake device (14) associated to one of the exhaust valve (12), said compression brake device (14) being configured to place said exhaust valve (12) in an open position during a compression stroke of the internal combustion engine (10) when activated,
   said control unit (15) being intended to be operatively connected to the oil circuit (13) and the compression brake devices (14), and configured to receive the shutdown signal and send commands to the internal combustion engine (10), and further configured to:
send a command (205) of measuring an oil pressure (Poil) in the oil circuit (13),
if the oil pressure (Poil) is greater than or equal to a pressure threshold (Pth), send an activation command (210) of the compression brake devices (14) during the compression stroke,
if the oil pressure (Poil) is lower than the pressure threshold (Pth), send a command (220) of increasing the oil pressure (Poil) to the pressure threshold (Pth) and an activation command (210) of the compression brake devices (14) during the compression stroke once the oil pressure (Poil) has reached the pressure threshold (Pth).

Example 15: A vehicle (1) comprising an internal combustion engine (10) of any one of examples 8 to 13.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A method to shut down an internal combustion engine further to a shutdown signal, said internal combustion engine comprising:
a plurality of cylinders,
a valves system comprising, for each cylinder, at least one exhaust valve configured to evacuate exhaust gas from the combustion,
an oil circuit fluidically connected to the valves system to provide oil at a predefined oil pressure to allow the valves to open and close,
for each cylinder: a compression brake device associated to one of the exhaust valve, said compression brake device being configured to place said exhaust valve in an open position during a compression stroke of the internal combustion engine when activated, a control unit operatively connected to the oil circuit and the compression brake devices, and configured to receive the shutdown signal and send commands to the internal combustion engine,
said method comprising the steps of, after receiving the shutdown signal by the control unit:
measuring an oil pressure in the oil circuit,
if the oil pressure is greater than or equal to a pressure threshold, activating the compression brake devices during the compression stroke,
if the oil pressure is lower than the pressure threshold, increasing the oil pressure to the pressure threshold and activating the compression brake devices during the compression stroke once the oil pressure has reached the pressure threshold.

2. The method of claim 1, the internal combustion engine comprising piston cooling jet valves fluidically connected to the oil circuit, wherein the step of increasing the oil pressure comprises the step of closing the cooling jet valves.

3. The method of claim 1, the oil circuit comprising a variable oil pump configured to dynamically adapt the oil pressure to a target pressure within the oil circuit, wherein the step of increasing the oil pressure comprises the step of activating the variable oil pump.

4. The method of claim 1, further comprising a step of deactivating the compression brake devices when the internal combustion engine has reached a predefined non-zero engine speed.

5. The method of claim 1, further comprising a step of stopping fuel injection into the plurality of cylinders, simultaneously or prior to the step of activating the compression brake devices.

6. The method of claim 1, further comprising a step of increasing the backpressure on the pistons of the plurality of cylinders), simultaneously or prior to the step of activating the compression brake devices.

7. The method of claim 1, each compression brake device comprising an hydraulic actuator, wherein the step of activating the compression brake devices comprises the step of providing the hydraulic actuators with oil at a predetermined pressure.

8. An internal combustion engine comprising:
a plurality of cylinders,
a valves system comprising, for each cylinder, at least one exhaust valve configured to evacuate exhaust gas from the combustion,
an oil circuit fluidically connected to the valves system to provide oil at a predefined oil pressure to allow the valves to open and close,
for each cylinder: a compression brake device associated to one of the exhaust valve, said compression brake device being configured to place said exhaust valve in an open position during a compression stroke of the internal combustion engine when activated, a control unit operatively connected to the oil circuit and the compression brake devices, and configured to receive the shutdown signal and send commands to the internal combustion engine,
said control unit being further configured to:
send a command of measuring an oil pressure in the oil circuit,
if the oil pressure is greater than or equal to a pressure threshold, send an activation command of the compression brake devices during the compression stroke,
if the oil pressure is lower than the pressure threshold, send a command of increasing the oil pressure to the pressure threshold and an activation command of the compression brake devices during the compression stroke once the oil pressure has reached the pressure threshold.

9. The internal combustion engine of claim 8, further comprising piston cooling jet valves fluidically connected to the oil circuit, wherein the control unit is configured to send a command of closing the cooling jet valves to increase the oil pressure.

10. The internal combustion engine of claim 8, wherein the oil circuit comprises a variable oil pump configured to dynamically adapt the oil pressure within the oil circuit, wherein the control unit is configured to send an activation command of the variable oil pump to increase the oil pressure.

11. The internal combustion engine of claim 8, wherein the control unit is configured to send a deactivation command of the compression brake devices when the internal combustion engine has reached a predefined non-zero engine speed.

12. The internal combustion engine of claim 8, wherein the control unit is configured to send a command of stopping fuel injection into the plurality of cylinders, preferably simultaneously to the activation command of the compression brake devices.

13. The internal combustion engine of claim 8, wherein the control unit is configured to send a command of increasing the backpressure on the pistons of the plurality of cylinders, preferably simultaneously to the activation command of the compression brake devices.

14. A control unit intended to equip an internal combustion engine comprising:
a plurality of cylinders,
a valves system comprising, for each cylinder, at least one exhaust valve configured to evacuate exhaust gas from the combustion,
an oil circuit fluidically connected to the valves system to provide oil at a predefined oil pressure to allow the valves to open and close,
for each cylinder: a compression brake device associated to one of the exhaust valve, said compression brake device being configured to place said exhaust valve in an open position during a compression stroke of the internal combustion engine when activated,
said control unit being intended to be operatively connected to the oil circuit and the compression brake devices, and configured to receive the shutdown signal and send commands to the internal combustion engine, and further configured to:
send a command of measuring an oil pressure in the oil circuit,
if the oil pressure is greater than or equal to a pressure threshold, send an activation command of the compression brake devices during the compression stroke,
if the oil pressure is lower than the pressure threshold, send a command of increasing the oil pressure to the pressure threshold and an activation command of the compression brake devices during the compression stroke once the oil pressure has reached the pressure threshold.

15. A vehicle comprising an internal combustion engine of claim 8.
